(19) United States
(12) Patent Application Publication
(10) Pub. No.: US 2016/0016785 A1
(43) Pub. Date: Jan. 21, 2016

(54) Device for Sealing and Evacuating a Container Having a Paste-Like Liquid

(71) Applicant: Udo TARTLER, Lützelbach-Haingrund (DE)

(72) Inventor: Udo Tartler, Lützelbach/Haingrund (DE)

(21) Appl. No.: 14/782,273

(22) PCT Filed: Apr. 9, 2014
(86) PCT No.: PCT/EP2014/000946

§ 371 Date: Oct. 2, 2015

(30) Foreign Application Priority Data
Apr. 9, 2013 (DE) 10 2013 005 965.8

(51) Int. Cl. B67D 7/64; B67D 7/02

(52) U.S. Cl. CPC B67D 7/645; B67D 7/0227

(57) ABSTRACT

The invention relates to a device (2) for sealing and evacuating or applying gas pressure to a paste-like liquid in a container, the interior chamber thereof having a cylindrical inner contour (12). Said device comprises:
a seal (8) which is arranged on a circumference of the device (2) and is adapted to be inserted into the cylindrical inner contour (12) of a container in order to seal the circumference of said container, and which delimits the exterior (18) of the device (2) from the interior (20) of the device;
a connection device (22) which is arranged on the exterior (18) of the device (2) and which is configured for connecting an evacuation pump;
and an open-pored, porous wall (24) in the interior of the device (2), said wall having a conduit connection (25) to the connection device (22).

The invention relates to a device for sealing and evacuating or applying gas pressure to an especially paste-like liquid in a container, the interior chamber thereof having a cylindrical inner contour (12).

It is a known procedural task, for example, in the manufacture and processing of plastics, to convey paste-like (highly viscous) materials (which usually are not or do not need to be mixed and which are dispensed phase-stable into cylindrical barrels, usually of sheet metal, for purposes of storage and transport) from the barrels with pumps (generally special pumps for highly viscous liquids) for subsequent processing. Because the materials are not self-leveling, meaning that they are so viscous that they do not form an even horizontal liquid surface simply by virtue of their own weight, so-called “follower plates” are used (and the conveyor pumps are usually mounted on them). These follower plates are cover devices (following removal of the actual barrel lid) that are inserted into the barrel and that are equipped with sealing rings which create a complete seal of the follower plate with the wall of the barrel. They in this way form a hermetically sealed, rigid covering above the liquid and, together with the barrel container, completely envelop and seal the liquid. The follower plates are then actively pressed onto the material and/or slide downward under their own weight when material is removed. To this purpose, the containers used in this context are usually barrels, the interior chamber of which has a cylindrical, specifically circular-cylindrical inner contour (possibly with stiffening longitudinal ribbing), whereby the inner contour usually opens outward without tapering into an outer opening of the inner contour, namely into the barrel opening.

In any case, it is of central importance for the pumping of highly viscous liquids, especially due to the properties of the pumps used, that no or as few and as small as possible air pockets are found in the liquid, thus also in particular in the barrel and underneath the follower plate.

This results in the problem, when using follower plates (and regularly as a consequence when changing barrels in the industrial process, namely when a barrel is empty and thus needs to be replaced with a full barrel), of absolutely ensuring that no air finds its way into the conveyor or dispensing pump. Because the barrels are not usually filled to the brim, this results in a certain quantity of air extending from the material surface to the face of the follower plate (lid opening of the barrel). This air escapes, in keeping with the state of art, through bleed devices in the form of bores with a manual seal, similar to a threaded rod, or through manual or pneumatic and/or electrical ball valves. These bleed devices are opened when the follower plate is retracted into the barrel. The resulting air pressure escapes via the bleed device. Even here at the start, there is a risk that material will be sprayed outward through the bleed device, as the bleed device can still contain material from the last barrel change, and material can also be conveyed by the flowing out of air. Uncontrolled, rapid collapse of the follower plate can also occur when the air escapes suddenly. Because the bleed device needs to remain open until it contains absolutely no more air, it is often not possible for the user to avoid reaching into the barrel to, for example, change the cups in which the material from the bleed device is collected. This can result in serious injuries for the user in the event of a sudden collapse of the follower plate or the risk of spraying.

In procedural terms, air in the system presents an extremely disadvantageous situation, as the conveyor pumps cannot compress this against the material found in the system as of a certain quantity and size of the air pockets, and/or because the incorporated air results in mixing ratio problems or even in the abort of the process. This means that users accept having to remove a large quantity of material from the bleed device (and thus losing it) in order to ensure to the greatest extent possible that no air remains in the system.

The invention relates to the task of creating a device for sealing and evacuating or applying gas pressure to an especially paste-like liquid in a container that is more procedurally and environmentally-friendly and more economical, and in particular, which overcomes the previously named disadvantages.

This task is addressed by a device with the features of claim 1. Preferred configurations are indicated in the sub-claims.

The device to which the invention relates serves the purpose of sealing and evacuating or applying gas pressure to an especially paste-like liquid in a container, for example, in the procedural processes previously described here. The invention prevents the entry of air into the system, the danger of spraying, material loss, as well as danger to the user when using the device, and especially when changing containers.

The device to which the invention relates has a seal that is oriented and adapted to the circumference of the device, which can be used in a circumferentially sealing fashion in the cylindrical inner contour of a container (especially one of the already described containers). The inner contour of the container, to which the device to which the invention relates is adapted, preferably opens without tapering into an opening outside of the container. The inner contour should preferably be circular-cylindrical; especially preferable is the circular-cylindrical inner contour of a smooth-walled steel plate covered barrel with a clamping ring lock (the diameter of which amounts to 572 mm in a widely available design). The inner contour to which the invention is adapted can have ribbing (or other structures, for example, for stiffening the barrel), especially in the direction of the cylinder axis. To this purpose, the seal is preferably to be adapted, in that it, for example, snuggles elastically into the form of this structure.

The seal of the device to which the invention relates delimits an exterior of the device from an interior of the device. A connection device is found on the exterior of the device that is set up for the (direct) connection of a vacuum pump. However, a line can also be (indirectly) connected to the connection device that is then connected by a line with a vacuum pump. “Vacuum pump” or “evacuation pump” thereby stands for a gas conveyor pump or system that is set up to create a vacuum and/or (especially for the disassembly of an empty barrel in the processes described above) overpressure. Overpressure can also be incorporated from a compressed air network that is often available as a system in business establishments.

The device to which the invention relates also has an open-pored, porous wall in the interior of the device, said wall having a conduit connection with the connection device. The porous material allows the gas (especially air) to be suctioned off through, while it represents a kind of labyrinth seal for the highly paste-like material. The porous wall preferably consists of aluminum granulate-epoxy resin composite material, for example, Metapor® from Hohnen & Co, Bielefeld. However, any material and structure (open-pored means porous here) that allows air but no liquids to penetrate is suitable. For example, a fleece like Gore-Tex® is conceivable, whereby such non-inherently stable materials and structures may require a form-maintaining support structure.

In order that the pneumatic through transmission from the inside to the outside of the device takes place as free of restriction as possible, and that constriction does not cause a loss of pressure at the transition between the open-pored, porous wall and the conduit connection for the connection device, the porous wall can pass through an intermediate cavity into the conduit connection with the connection device, whereby the intermediate cavity should preferably have a line cross-section larger than the conduit connection.

When positioning the follower plate, the air in the container (especially above the material surface), in the material (in the form of air pockets or bubbles, especially just below the material surface), in the (conveyor/dispensing) pump and, to the extent possible, also in the lines conveying the material, can thus be directly suctioned off through the follower plate.

A vacuum can also be created during the actual removal of material, meaning while the container is emptied in operation, either continuously or at intervals, in order to draw out air pockets in the material that are not initially close beneath the surface of the material, but which then move upward during the removal of material.

The combination of vacuum venting with an “air-permeable” material, through which the air is largely suctioned off with a vacuum pump, but which (due to the small pore size of preferably less than 1 mm, but also due to the “labyrinthine” property of the open-pored porous material) does not allow the paste-like liquid to permeate, let alone pass through, prevents the previous (always involving material loss) material discharge, which used to in fact be necessary as a control phenomenon with conventional venting. In addition, no actions need to be carried out on the device by persons during the barrel change, so that the related hazards are avoided.

Depending upon the viscosity and the phase stability of the material to be sealed, an average pore diameter of between 0.0001 and 1 mm has proven itself for the porous wall. Thus, for a material with a viscosity approximately that of water (or for a higher viscosity but phase-unstable material, which discharges a phase with a viscosity approximately like that of water under the evacuation vacuum), an average pore diameter of between approx 0.001 and 0.01 mm is suitable, while an average pore diameter of between 0.1 and 1 mm is advantageous for the sealing of a paste-like liquid with a viscosity between 50,000 and 200,000 mPas, like, for example, Raku-Tool® CP-6070 from Rampf Tooling or a similar material of other manufacturers.

Thanks to the same connection device to which the invention relates, the air can also be introduced while pulling out (using a, for example, hydraulic, pneumatic or electrical actuator) the device from the container (for example, to replace an empty barrel with a full one), in order that no vacuum caused by the pulling out of the follower plate hinders disassembly. Also conceivable, however, is an active “pneumatic” pulling out of the device, in that air is pumped underneath the device so that the device is pushed out of the container; especially preferable: the combination of active pulling out with an actuator and the insertion of air beneath the follower plate.

Thanks to the extensive insertion of air through the porous, air-permeable material (as a kind of diffuser of the escaping air), the danger of spraying when pulling out is also avoided.

The invention, together with the control system set up on it, can ensure that the fully automatic insertion and removal of the follower plate becomes a safe and unproblematic standard process that also results in savings, because no material is lost. Barrel changes, also especially of the widely available cylindrical clamping ring lid barrels with paste-like materials, for example, with the industrial mixing process of plastic with two or more components, can be carried out without material loss and with a significantly increased level of safety.

This and other advantages and features of the invention are described in more detail on the basis of the following illustrations of a design example of the invention.

The figure shows a cut side view of a device to which the invention relates and a part of a conveyor pump unit mounted directly upon it that is inserted in a barrel.

Device 2 illustrated in the figure serves the purpose of sealing and evacuating or applying gas pressure to an especially paste-like liquid 4 in a container 6.

Device 2 shows a circular rubber seal 8, which is oriented to the circumference of device 2. It has four lamella rings 10 lying axially next to one another and protruding radially outward with a graduated exterior diameter (however, all other possible seal types and designs are also conceivable, like, for example, one or more sealing rings with a solid or hollow (hose-like cross-section). Seal 8 is thus adapted so that it can be used in the circular-cylindrical inner contour 12 of a steel plate barrel 6 with a circumferential sealing function. The inner contour of the barrel 6, to which the device 2 to which the invention relates has been adapted, opens without tapering in the barrel opening 16 outside of the steel plate barrel with lid, whereby the barrel opening 16 can be sealed for storage and transport of the highly viscous material 4 contained within it with a plate metal lid with a clamping ring lock (not shown).

The seal 8 of the device 2 delimits an exterior 18 of the device 2 from an interior 20 of the device 2. A connection device 22 in the form of an inner thread 22 is positioned on the exterior 18. A line (not shown) can be connected (screwed in) to the connection device 22. This can then be connected with a pneumatic conveyor pump (electrical or pneumatic vacuum pump; not shown). The pump is set up to generate a vacuum and (especially for the disassembly of the device 2 from the barrel 6 after it has been emptied) overpressure. However, air pressure can also be incorporated from the conventional pressure network (not shown) by way of the connection device 22.

The device 2 also possesses an open-pored, porous wall 24 that forms a ring-shaped area 26 of the surface on the interior 20 of the device 2. The porous wall 24 is connected by a line 25 with the connection device 22. The porous material 24 allows the gas 28 (especially air) to be suctioned off through, while it represents a kind of labyrinth seal for the paste-like material 4. The porous wall 24 consists of aluminum granulate-epoxy resin composite material with an average pore diameter of 0.4 mm. The highly viscous material 4 is, for example, Raku-Tool® CP-6070 from Rampf Tooling.

In order that the pneumatic passage from the interior 20 to the exterior 18 of the device 2 takes place as free of throttle as possible and, especially at the transition between the open-pored, porous material 24 and the conduit connection 25 with the connection device 22, that no bottleneck results in a loss of pressure, the porous material 24 is connected with the conduit connection 25 by a transition cavity in the form of four ring channels 30 lying axially next to one another and protruding radially inward into the porous material 24, and thus with the connection device 22, whereby the ring channels 30 are connected with one another by (not shown, distributed over the circumference) by axial channels. The porous shaped piece 24 used is sealed with sealing rings 33 in the joint gaps with the base body 34 in order that neither material nor compressed air can seek out a “detour” around the porous shaped piece 24 to the transition cavities 30 than that through the porous material 24.

The unit 32 is an element of a conveyor pump through which the viscous liquid 4 can be discharged safely out of the barrel 6 without air pockets. This takes place following the placing of the follower plate 2 and the evacuation of the air 28 from the intervening space between the device 2 and the (recognizably not horizontal) level of the viscous liquid 4, as well as from the line channels of the pump unit 32.

On the whole, device 2 and barrel 6 are aligned rotational-symmetrically around the axis 34 and, for the described insertion of the follower plate 2 into the barrel 6, rotational-symmetrically toward one another around the shared axis 34. The barrel 6 is only shown recognizably from the opening area at the top end of the barrel 6, where the barrel opening is located. The lower area of the barrel with the barrel bottom has been eliminated to reduce the size of the illustration.

1. A device for sealing and evacuating or applying gas pressure to a paste-like liquid in a container, an interior chamber thereof having a cylindrical inner contour (12), the device comprising:
a seal (8) which is arranged on a circumference of the device (2) and is adapted to be inserted into the cylindrical inner contour (12) of the container in order to seal the circumference of said container, and which delimits the exterior (18) of the device (2) from the interior (20) of the device;
a connection device (22) which is arranged on the exterior (18) of the device (2) and which is configured for connecting to an evacuation pump; and
an open-pored, porous wall (24) in the interior (20) of the device (2), said wall having a conduit connection (25) to the connection device (22).

2. The device in accordance with claim 1, wherein the porous wall (24) has an average pore diameter of between 0.0001 and 1 mm.

3. The device in accordance with claim 1, wherein the porous wall (24) has an average pore diameter of between 0.1 and 1 mm for the sealing of a highly paste-like liquid with a viscosity between 50,000 and 200,000 mPas.

4. The device in accordance with claim 1, wherein the porous wall (24) comprises a aluminum granulate-epoxy resin composite material.

5. The device in accordance with claim 1, wherein the porous wall (24) has a conduit connection (25) to the connection device (22) through a transition cavity.

6. The device in accordance with claim 1, wherein the seal (8) is adapted to be used as a circumferential seal in the circular-cylindrical inner contour (12) of the container.

7. The device in accordance with claim 1, wherein the seal (8) is adapted to be used as a circumferential seal in the circular-cylindrical inner contour (12) of a steel plate lidded barrel (6) with a clamping ring lock.
